(19) United States
(12) Patent Application Publication
(10) Pub. No.: US 2010/0037739 A1
(43) Pub. Date: Feb. 18, 2010

(54) Power cutting tool with overhead sensing system

(76) Inventors: Will H. Anderson, Los Gatos, CA (US); Ryan J. Connolly, Menlo Park, CA (US); Jeffrey Y. Hayashida, San Francisco, CA (US); William R. Knapp, Salinas, CA (US); Jean-Pierre Krauer, San Jose, CA (US); Brian Lamb, Menlo Park, CA (US); John Larkin, Monterey, CA (US); Kyle L. Petrich, New York, NY (US); David C. Shafer, Menlo Park, CA (US)

Correspondence Address: K&L GATES LLP, 535 SMITHFIELD STREET, PITTSBURGH, PA, 15222, US

(21) Appl. No.: 11/444,712

(22) Filed: Jun. 1, 2006

Related U.S. Application Data
(60) Provisional application No. 60/686,165, filed on Jun. 1, 2005.

(51) Int. Cl. B26D 7/24; B27B 5/38

(52) U.S. Cl. 83/58; 83/397; 83/477.2

(57) ABSTRACT

A power cutting tool, such as a table saw, comprising a sensing system for detecting certain conditions with respect to an exposed blade of the power cutting tool is disclosed. Several embodiments of the sensing system comprise at least one sensor located above the blade and positioned to (1) monitor one or more volume zones adjacent the blade, (2) detect when an object enters one or more of the zones, and (3) trigger a reaction system in response to the detection. Another embodiment uses an optical sensor to measure the height of objects approaching the blade to detect an increase in the height beyond a predetermined threshold. Still another embodiment uses an optical distance sensor to detect the occurrence of a work piece lifting from the table top which can indicate that a kick-back condition is imminent. The reaction system can be triggered when such a condition is detected.

### CROSS-REFERENCE TO RELATED APPLICATIONS

The present application claims priority to and hereby incorporates by reference U.S. provisional patent application Ser. No. 60/686,165, entitled “Overhead Sensing System,” filed 1 Jun. 2005, by W. H. Anderson et al.

### BACKGROUND OF THE INVENTION

The present invention generally relates to sensing or detecting systems, and more particularly to sensing or detecting systems for power cutting tools.

Detection or sensing systems have been developed for use with various kinds of manufacturing equipment and power tools. Such detection systems are operable to trigger some type of reaction mechanism when certain conditions are sensed or detected. For example, it is known to use a capacitive contact sensing system to detect contact between an operator and a blade of a table saw. In such systems, a signal is capacitively coupled to the blade and the signal on the blade is monitored to detect changes in the signal indicative of contact between the operator and the blade. Such capacitive sensing systems, however, are only practically able to detect contact between the operator and the blade. Such systems cannot practically detect the proximity of the operator to the blade. Detection systems that could detect when the operator or other object comes near the blade would be desirable.

### SUMMARY OF THE INVENTION

In one general aspect, the present invention is directed to a power cutting tool, such as a table saw, comprising a sensing system for detecting a condition with respect to an exposed, moveable blade of the power cutting tool. Several embodiments of the sensing system comprise at least one sensor located above the blade and positioned to (1) monitor one or more volume zones adjacent the blade, (2) detect when an object enters one or more of the zones, and (3) trigger a reaction system in response to the detection.

According to various embodiments, the sensing system comprises an electrically conductive frame connected to the cutting platform (e.g., a table where the power cutting tool is a table saw). The frame may be spaced apart from and parallel to the cutting surface, and may surround at least a portion the blade. The sensing system also comprises an electrically conductive region (e.g. strip) on the cutting surface, facing the electrically conductive frame. When energized, a capacitive field extends between the electrically conductive strip and the electrically conductive frame. Changes in the field can indicate a condition relative to the blade, which can be used to trigger the reaction system.

According to other embodiments, the sensing system comprises an optical energy detection system for detecting optical energy propagating between the frame and one or more detection zones on the cutting (or work) surface. The detection zone(s) may surround at least a portion of the blade. When two or more detection zones are used, the detection zones may be concentric around the blade. The detection zone may reflect light emitted from an emitter on the frame back to the frame for detection by a detector. Blockage of the optical energy path may indicate a condition relative to the blade, which can be used to trigger the reaction system. According to other embodiments, the detection zone(s) may comprise optical energy emitters or detectors.

According to still other embodiments, the sensing system may comprise an optical energy emitter/detector pair positioned over the cutting surface of the cutting platform near the front of the blade. In this way, the height of objects near the front of the blade can be detected. An object that is too high may be used to trigger the reaction system.

In another embodiment, an optical distance sensor is embedded in the cutting surface of the cutting tool near the back of the blade to detect the occurrence of a work piece lifting from the cutting surface, which can indicate that a kick-back condition is imminent. The reaction system can be triggered when such a condition is detected.

### DESCRIPTION OF THE DRAWINGS

Various embodiments of the present invention are described herein by way of example in conjunction with the following figures, wherein:

FIG. 1A is a simplified perspective view of an embodiment of the present invention, particularly illustrating a capacitive overhead sensing system implemented in a table saw;

FIG. 1B is a simplified end view of the embodiment shown in FIG. 1A;

FIG. 2A is a simplified perspective view of another embodiment of the present invention, particularly illustrating an optical overhead sensing system implemented in a table saw;

FIG. 2B is a simplified end view of the embodiment shown in FIG. 2A;

FIG. 3A is a simplified perspective view of another embodiment of the present invention, particularly illustrating another optical overhead sensing system implemented in a table saw, wherein the system has more than one detection zone;

FIG. 3B is a simplified end view of the embodiment shown in FIG. 3A;

FIG. 4A is a simplified perspective view of another embodiment of the present invention, particularly illustrating another optical overhead sensing system implemented in a table saw;

FIG. 4B is a simplified end view of the embodiment shown in FIG. 4A;

FIG. 5 is a simplified side view of another embodiment of the present invention, particularly illustrating an optical overhead sensing system implemented in a table saw, and particularly configured to measure the height of objects near the front of the blade;

FIG. 6A is a simplified perspective view of another embodiment of the present invention, particularly illustrating an optical sensing system implemented in a table saw, wherein the system is configured to detect a kickback condition; and

FIG. 6B is a simplified side view of the embodiment shown in FIG. 6A.

### DETAILED DESCRIPTION

The present invention is directed generally to a power cutting tool, such as a table saw, comprising a sensing system for detecting certain conditions with respect to the blade of the cutting tool. There are several embodiments disclosed herein that relate to overhead frame supports for sensing the presence of an object in close proximity to the rotating blade of a table saw. While the embodiments that are shown and described below are implemented in the environment of a table saw, it should be understood that they could also be implemented in other types of power cutting tools, such as miter saws, chop-saws, arm saws, band saws, etc. The use of an overhead frame structure enables accurate detection of the proximity of an object in the zones of detection. Other embodiments employ a structure mounted in the cutting surface of the power cutting tool in position to monitor the lifting of a work piece during cutting thereof by the table saw, with the lifting action often being indicative of an impending kick-back situation.

The detection systems described herein may be used with a reaction system, such as those which either retract and/or stop the blade when certain conditions are detected. One such reaction system, which retracts the blade from the cutting zone when certain conditions are detected, is described in U.S. patent application Ser. No. 11/374,319, filed 13 Mar. 2006, which is hereby incorporated by reference. In addition to or in lieu of such a reaction system, the reaction system for the power cutting tool 10 may reduce the RPM of the motor spinning the blade when the certain conditions are detected. Additionally, the reaction system may sound an audible alarm when certain conditions are detected or provide a visual indication that the condition(s) has been detected.

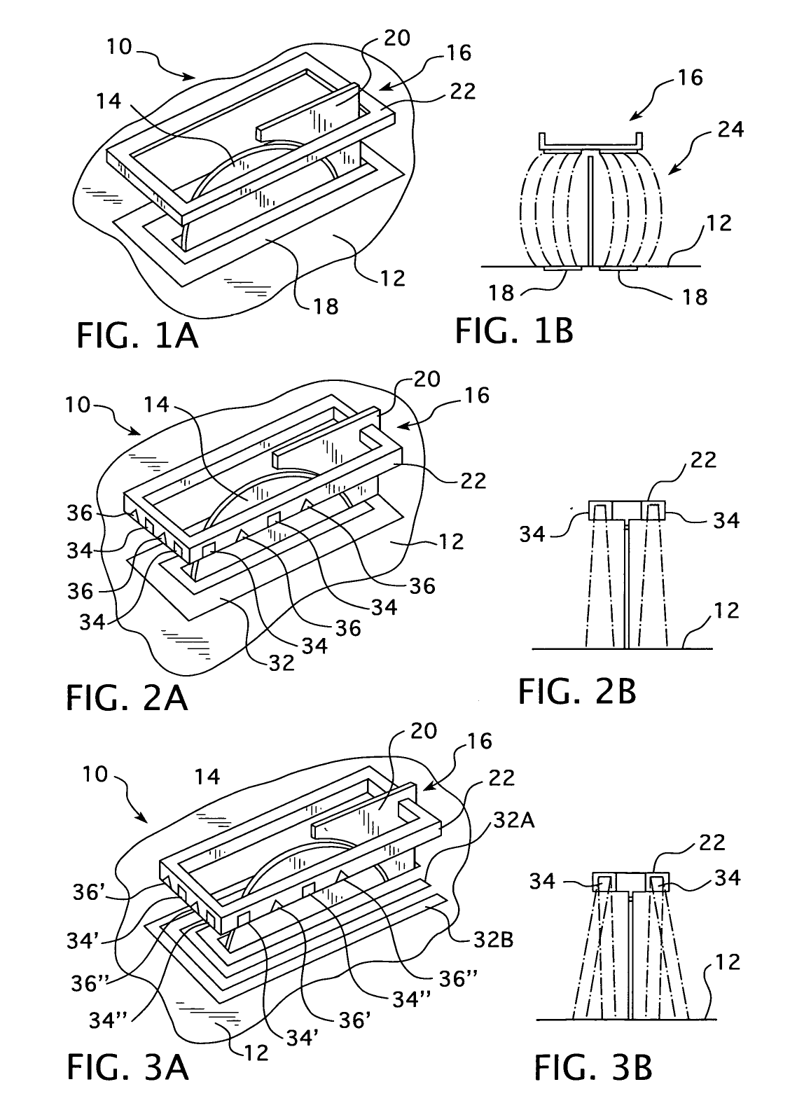

FIG. 1A illustrates a power cutting tool 10 according to various embodiments of the present invention. In the illustrated embodiment, the power cutting tool 10 is a table saw comprising a table top or cutting surface 12, a saw blade 14, and a frame structure 16 above and spaced-apart from the cutting surface 12. The frame structure 16 in the illustrated embodiment is part of a capacitive sensing system that also includes an electrically conductive strip 18 on the table top 12 in the shape of a rectangle that surrounds the blade 14. The conductive strip 18 is preferably embedded in or bonded to the table top 12, and is preferably formed with an electrically insulating top layer that may be formed or otherwise applied to a metal table top. The frame structure 16, according to the illustrated embodiment, has a vertically oriented splitter 20 positioned behind the blade 14 that extends forwardly over a portion of the exposed blade 14. The frame structure 16 may also include an electrically conductive upper frame 22 mounted to the splitter 20 that generally surrounds the blade 14 above the cutting surface 12. In the illustrated embodiment, the upper frame 22 is rectangular and is preferably approximately the same size as the rectangular conductive strip 18 on the table top, but spaced away from the conductive strip 18 by a distance that varies in accordance with the height of the frame 16, which may vary with the height of the blade 14. This is because the splitter 20 is preferably connected to the frame structure of the blade assembly so that as the blade 14 is elevated or lowered, the splitter 20 maintains a relatively close spacing relationship with the blade 14 as shown in FIG. 1A. Accordingly, the splitter 20 (and hence the upper frame 22) may move up and down with the blade 14. Thus, the distance between the upper frame 22 and the rectangular conductive strip 18 can vary.

The upper frame 22 and the lower conductive strip 18 are preferably in parallel with each other, and are preferably of the same geometric shape with identical (or nearly identical) dimensions. In the illustrated embodiment, the upper frame 22 and the lower conductive strip 18 are both rectangular, although in other embodiments different shapes and/or dimensions may be utilized.

The lower strip 18 and upper frame 22 are electrically energized relative to each other with a sufficient voltage to produce a capacitive field that extends between them, which is diagrammatically illustrated by the curved lines 24 in FIG. 1B. The capacitive field is monitored so that if an object is brought into the capacitive field, the capacitance that is being monitored will necessarily change, which may be used to trigger the reaction system if the changes are sufficient to indicate a condition worthy of triggering the reaction system. It is known that a person's hand can produce capacitance changes that are different in magnitude and phase compared to that which is produced by a work piece, such as a piece of wood. Procesing circuitry in a control system (not shown) can differentiate between these two conditions and appropriately trigger the reaction system when a person's hand is detected in the field.

The use of the overhead frame configuration, such as illustrated in FIGS. 1A and 1B, not only senses proximity to the blade 14, but can prevent a slip condition where an object may be prevented from contacting the blade because it is physically blocked from doing so by the frame 22. It is also possible to sense conditions that should trigger the reaction system at a higher elevation above the table top 12 than can generally be achieved with a capacitive sensing apparatus embedded in the table. The presence of the splitter 20 also reduces the risk of a kick back condition.

A second embodiment of a power cutting tool 10 according to the present invention is shown in FIGS. 2A and 2B. This embodiment is similar to the embodiment of FIGS. 1A-1B, except that in the embodiment of FIGS. 2A-2B the upper frame 22 includes a number of optical emitters 34 and optical detectors 36. The embodiment of FIG. 2A-2B also does not require the lower conductive strip 18 of FIGS. 1A-1B. Instead, the embodiment of FIG. 2A-2B may comprise a detection zone 32 on the table top 12 oriented around the blade 14 and facing the upper frame 22. In this embodiment, the emitters 34 emit optical energy downward toward the table top 12, which is reflected by the detection zone 32, with the reflected optical energy detected by the detectors 36 on the upper frame 22. As such, the detection zone 32 may comprise a number of reflectors that are capable of reflecting the optical energy from the emitters 34 back toward the upper frame 22 (and hence the detectors 36). The number of emitters 34 and detectors 36 is preferably sufficient to provide a generally continuous zone of detection around the blade 14.

The presence or absence of an object may be detected by the interruption of the light path between the emitters 34 and detectors 36. Further, the capability of differentiating wood from a portion of the operator may be obtained by differential reflectance, optical back-scattering effects, or by the operator wearing a glove having a specific signature. With such a light circuit detecting capability, it is apparent that the proximity of the object to the blade 14 can be detected and used to trigger the reaction system if necessary.

The wavelength of the optical energy may be in the visible, infrared or ultraviolet portions of the spectrum, or some other wavelength. Also, according to various embodiments, each emitter 34 and detector 36 pair may be implemented in a single integrated circuit device and it may be sufficient to provide a number of them around the frame 22 spaced at, for example, one to two inch intervals, although larger or smaller intervals may be utilized, or the spacing intervals may vary depending upon the location. In other embodiments, the emitters 34 may be located in the upper frame 22 and the detectors 36 located in the detection zone 32 or vice versa.

A third embodiment of the cutting tool 10 is shown in FIGS. 3A and 3B. This embodiment is similar to the embodiment of FIGS. 2A and 2B except that in the embodiment of FIGS. 3A-3B multiple detection zones 32A and 32B are used. The detection zones 32A and 32B may be generally concentric to one another relative to the blade 14. The inner zone 32A may be configured to operate with a first emitter/detector combination 34′-36′, whereas the second zone 32B may operate with a second emitter/detector combination 34″-36″. It should be understood that if the detection zones 32A and 32B are reflecting surfaces (e.g. if the detection zones 32A, 32B comprise reflectors to reflect optical energy back toward the frame 22), they are preferably angularly oriented in the table top 12 to reflect the light back to the appropriate detector. Also, it should be apparent that if the detectors do not operate on the principal of reflection and are mounted in the table top 12, the emitters 34′, 34″ may have a sufficiently narrow emitted beam so that a detector located in the detection zone 32B will not detect emitted light from emitters that are directed to the zone 32A and vice versa. Alternatively, there can be an emitter in the frame 22 that provides a broad beam of light to detectors in both zones 32A and 32B, and detectors in each of the zones 32A, 32B could independently detect the absence of emitted light, which may indicate that something is in one or both zones 32A and 32B.

Assuming that the emitter/detector combinations are operable to detect the presence of an object, the embodiment of FIGS. 3A-3B enables the approach velocity of the object to be detected by calculating the time difference between the outer zone 32B and inner zone 32A. This can be used to provide different reactions for penetration into different zones. In this regard, the reaction system can issue an audio warning before it triggers stoppage or retraction of the blade in response to penetration of different zones.

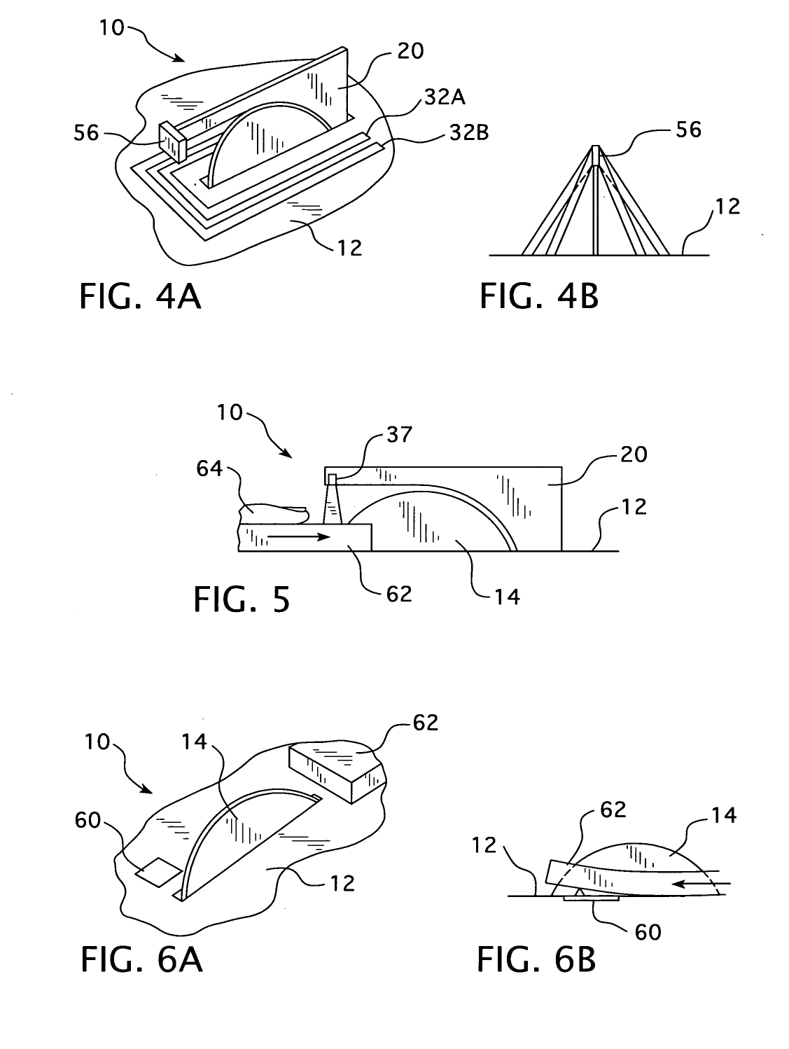

A fourth embodiment of the power cutting tool 10 is shown in FIGS. 4A and 4B. In this embodiment, the frame 22 includes, for example, a relatively small end portion 56 at the forward end of the splitter 20. A number of optical energy emitters (not shown) may be located in the end portion. In this embodiment, it is preferable that the detection zones 32A and 32B have optical energy detectors (not shown) located in the table top 12, although it is possible to have a number of mirrors located along the zones 32A-32B configured to reflect energy back toward detectors located in the end portion 56. However, because the blade 14 can still typically be raised or lowered in most table saws, if there are mirrors embedded in the table top 12 in the zones 32A and 32B, the angle of reflection would necessarily change as the blade elevation is changed.

In this embodiment, there preferable is a sufficient number of emitters to direct light toward all of the detectors and any one of the detectors could provide a detector signal indicating the presence of an object during operation in the sensing zone around the blade 14. Having the detectors in the end portion 56, while possible, provides a greater engineering challenge than locating the emitters in the detection zones 32A and 32B.

A fifth embodiment of the cutting tool 10 is shown in FIG. 5. In this embodiment, a single optical emitter/detector pair 37 is connected to the splitter 20 above the table. An optical energy beam is directed downwardly from the emitter onto the work piece 62 and the height of the work piece 62 above the table 12 can be effectively measured based on the return signal detected by the detector. As the work piece 62 is moved into the blade 14, any substantial detected increase in the height can be interpreted as an undesired object on top of the work piece 62 that can be used to trigger the reaction system.

A sixth embodiment of the cutting tool 10 is shown in FIGS. 6A and 6B. This embodiment does not have an overhead sensing structure like the previous embodiments. In this embodiment, an optical distance sensor 60, such as, for example, an optical mouse, is embedded in the table 12 at a location near the rear reach of the blade 18, with the optical distance sensor 60 positioned to monitor a work piece 62 as it is being cut. If the optical distance sensor 60 detects that the work piece 62 is rising from the surface 12, this is an indication that a kick-back situation may be occurring. The detection of the work piece rising preferably triggers the actuation of the reaction system. It should be understood that the embodiment of FIGS. 6A and 6B does not include a splitter. In this regard, it should be understood that the embodiment of FIG. 6 could be used in combination with one of the overhead detecting embodiments shown in FIGS. 1-5 or it could be used separately and independently from the other embodiments.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

1-3. (canceled)

4. A power cutting tool comprising:
a platform having a cutting surface;
a circular, moveable blade for cutting an object on the cutting surface, the blade extending above the cutting surface and having a front, a back, and an apex;
a splitter extending from the cutting surface adjacent to the back of the blade and extending forwardly over the apex of the blade;
a frame connected to the splitter and spaced apart from, parallel to, and facing the cutting surface, the frame defining a closed-end configuration with an opening therethrough, wherein the frame comprises;
left and right co-planer side portions that are spaced laterally from the blade when the blade is oriented in a plane perpendicular to the cutting surface;
a front portion that connects the left and right side portions, wherein the front portion is in front of the front of the blade; and
a rear portion that connects the left and right side portions and that is connected to the splitter, wherein the rear portion is behind the back of the blade, and wherein the left and right side portions, the front portion, and the rear portion are at an elevation relative to the cutting surface that is greater than the elevation of the apex of the blade relative to the cutting surface when the blade is oriented in a plane perpendicular to the cutting surface; and
an optical energy detection system for detecting optical energy propagating between the frame and at least one detection zone region on the cutting surface of the platform, wherein the optical energy detection system comprises:
a plurality of optical energy emitters connected to the left and right side portions and the front portion of the frame and facing the cutting surface;
a plurality of optical energy detectors connected to the left and right side portions and the front portion of the frame and facing the cutting surface; and
one or more optical energy reflectors in the detection zone region and facing the frame, such that the emitters and detectors are at an elevation relative to the cutting surface that is greater than the elevation of the apex of the blade relative to the cutting surface.

5. The power cutting tool of claim 4, wherein the at least one detection zone region surrounds at least a portion of the blade and faces the frame.

6-8. (canceled)

9. The power cutting tool of claim 4, wherein the optical energy detection system comprises first and second concentric detection zone regions surrounding at least a portion of the blade and facing the frame.

10. The power cutting tool of claim 9, wherein:
the first detection zone region comprises a first angled reflecting surface; and
the second detection zone region comprises a second angled reflecting surface.

11. The power cutting tool of claim 23, wherein:
the at least one detection zone comprises first and second concentric detection zone regions surrounding at least a portion of the blade and facing the frame;
the frame comprises first and second narrow-beam emitters;
the first detection zone region comprises a first detector oriented to receive optical energy from the first narrow-beam emitter; and
the second detection zone region comprises a second detector oriented to receive optical energy from the second narrow-beam emitter.

12. The power cutting tool of claim 23, wherein:
the at least one detection zone comprises first and second concentric detection zone regions surrounding at least a portion of the blade and facing the frame;
the frame comprises a plurality of broad-beam emitters;
the first detection zone region comprises a first detector oriented to receive optical energy from a first broad-beam emitter; and
the second detection zone region comprises a second detector oriented to receive optical energy from the first broad-beam emitter.

13-22. (canceled)

23. A power cutting tool comprising:
a platform having a cutting surface;
a circular, moveable blade for cutting an object on the cutting surface, the blade extending above the cutting surface and having a front, a back, and an apex;
a splitter extending from the cutting surface adjacent to the back of the blade and extending forwardly over the apex of the blade;
a frame connected to the splitter and spaced apart from, parallel to, and facing the cutting surface, the frame defining a closed-end configuration with an opening therethrough, wherein the frame comprises;
left and right co-planer side portions that are spaced laterally from the blade when the blade is oriented in a plane perpendicular to the cutting surface;
a front portion that connects the left and right side portions, wherein the front portion is in front of the front of the blade; and
a rear portion that connects the left and right side portions and that is connected to the splitter, wherein the rear portion is behind the back of the blade, and wherein the left and right side portions, the front portion, and the rear portion are at an elevation relative to the cutting surface that is greater than the elevation of the apex of the blade relative to the cutting surface when the blade is oriented in a plane perpendicular to the cutting surface; and
an optical energy detection system for detecting optical energy propagating between the frame and at least one detection zone region on the cutting surface of the platform, wherein the optical energy detection system comprises:
a plurality of emitters connected to the left and ride side portions and the front portion of the frame and facing the cutting surface; and
a plurality of detectors in the detection zone region and facing the lower surface of the frame, such that the emitters are at an elevation relative to the cutting surface that is greater than the elevation of the apex of the blade relative to the cutting surface.

24. A power cutting tool comprising:
a platform having a cutting surface;
a circular, moveable blade for cutting an object on the cutting surface, the blade extending above the cutting surface and having a front, a back, and an apex;
a splitter extending from the cutting surface adjacent to the back of the blade and extending forwardly over the apex of the blade;
a frame connected to the splitter and spaced apart from, parallel to, and facing the cutting surface, the frame defining a closed-end configuration with an opening therethrough, wherein the frame comprises;
left and right co-planer side portions that are spaced laterally from the blade when the blade is oriented in a plane perpendicular to the cutting surface;
a front portion that connects the left and right side portions, wherein the front portion is in front of the front of the blade; and
a rear portion that connects the left and right side portions and that is connected to the splitter, wherein the rear portion is behind the back of the blade, and wherein the left and right side portions, the front portion, and the rear portion are at an elevation relative to the cutting surface that is greater than the elevation of the apex of the blade relative to the cutting surface when the blade is oriented in a plane perpendicular to the cutting surface; and
an optical energy detection system for detecting optical energy propagating between the frame and at least one detection zone region on the cutting surface of the platform, wherein the optical energy detection system comprises:
a plurality of detectors connected to the left and ride side portions and the front portion of the frame and facing the cutting surface; and
a plurality of emitters in the detection zone region and facing the lower surface of the frame, such that the detectors are at an elevation relative to the cutting surface that is greater than the elevation of the apex of the blade relative to the cutting surface.

25. The power cutting tool of claim 4, wherein the optical energy comprises visible light energy.

26. The power cutting tool of claim 4, wherein the optical energy comprises infrared light energy.

27. The power cutting tool of claim 4, wherein the optical energy comprises ultraviolet light energy.
